(19) United States
(12) Patent Application Publication
(10) Pub. No.: US 2002/0126474 A1
(43) Pub. Date: Sep. 12, 2002

(54) Illumination device used in a compact disk receiving frame

(76) Inventor: Jack Lin, Taipei (TW)

Correspondence Address: JACK LIN, P.O. BOX 26-757, TAIPEI, TW

(21) Appl. No.: 09/803,118

(22) Filed: Mar. 7, 2001

(51) Int. Cl. F21V 33/00

(52) U.S. Cl. 362/127; 362/133

(57) ABSTRACT

An illumination device used in a compact disk receiving frame is disclosed. The illumination device includes a body. An electric wire is installed within the body. Another end of the electric wire is connected to a pressable switch. Each of two sides of the pressable switch is installed with a telescopic rod. A plate is installed between the two rod bodies. The plate serves to prevent from short circuit due to contact of the two rod bodies. One end of each of the two rod bodies is connected to a lampshade. A bulb is installed in the lampshade. Thereby, this illumination device is placed in the CD receiving frame so as to achieve the effect of illumination. Moreover, the user may read the data in the compact disks within the CD receiving frame conveniently.

### FIELD OF THE INVENTION

The present invention relates to an illumination device, and especially to an illumination device used in a CD (compact disk) receiving frame and thus, data (such as catalog or lyrics) on the compact disk can be read easily so that it is practical and convenient to the users.

### BACKGROUND OF THE INVENTION

Referring to FIG. 1, the structure of a prior CD receiving frame is illustrated. The structure has a receiving frame 10 which has an oblong shape. Two sides of the receiving frame 10 is installed with a plurality of spacers 11 which are correspondent to one another and spaced with an equal space. The spacers 11 may be arranged with a plurality of compact disks (not shown). In order that various data (such as data or lyrics) on the compact disk can be read easily, a lamp 12 is placed at the top of the receiving frame 10. The lamp 12 has a seat 121. The seat 121 is installed with a switch 122. The switch 122 may open or close the illumination device of the lamp 12. The seat 121 is extended with an electric wire 123. One end of the electric wire 123 may be inserted with a receptacle (not shown) for supplying power required by the lamp 12.

However, since the volume of the compact disk is not too large, although the receiving frame 10 may be arranged with a plurality of compact disks, the compact disks are stacked one by one. In order that the compact disks do not fall down, the width of the receiving frame 10 is approximately equal to the width of the compact disks so that the users may read all data (for example catalogs or lyrics) in the compact disks, the user may light up the lamp indoors or a lamp 12 at the top of the receiving frame 10. Since the width of the receiving frame 10 is limited, while the seat 121 of the lamp 12 is general larger than the top of the receiving frame 10. For one conforming the lamp 12 at the top of the receiving frame 10, since being confined by the volume thereof, the illumination effect is not preferred.

Since the lamp 12 is further arranged at the top of the receiving frame 10. The lamp 12 has no effect of fixing. If the user touches the receiving frame 10 or the lamp 12 carelessly, the lamp 12 will drop down from the receiving frame 10. A new lamp 12 is necessary so as to increase the burden of the user. Furthermore, since the electric wire 123 extended from the lamp 12 is exposed out of the receiving frame 10, the user is possibly stumbled by accident.

### SUMMARY OF THE INVENTION

Accordingly, the primary object of the present invention is to provide a illumination device used in a compact disk receiving frame, wherein the illumination device is combined with the CD receiving frame integrally. Therefore, the user is unnecessary to open the indoor lamp for reading data (such as catalogs or lyrics) in the compact disks. Therefore, the power is saved effectively. If the user touches the receiving frame or the lamp carelessly, the lamp will not drop down from the receiving frame. No new lamp is necessary so as to decrease the burden of the user.

To achieve the object, the present invention provides an illumination device used in a compact disk receiving frame. The illumination device includes a body. An electric wire is installed within the body. Another end of the electric wire is connected to a pressable switch. Each of two sides of the pressable switch is installed with a telescopic rod. A plate is installed between the two rod bodies. The plate serves to prevent from short circuit due to contact of the two rod bodies. One end of each of the two rod bodies is connected to a lampshade. A bulb is installed in the lampshade. Thereby, this illumination device is placed in the CD receiving frame so as to achieve the effect of illumination. Moreover, the user may read the data in the compact disks within the CD receiving frame conveniently.

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

The various objects and advantages of the present invention will be more readily understood from the following detailed description when read in conjunction with the appended drawing.

### BRIEF DESCRIPTION OF THE DRAWINGS

FIG. 1 is a perspective view of the compact disk receiving frame and a lamp of the prior art.

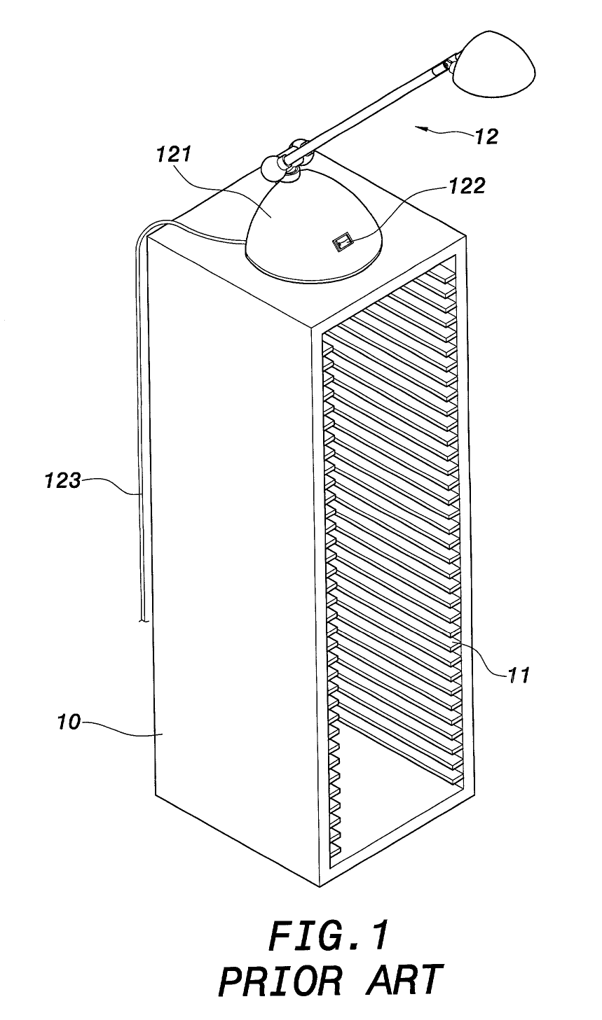

FIG. 2 is an exploded perspective view of the illumination device of the present invention.

FIG. 3 is an assembled perspective view of the illumination device according to the present invention.

FIG. 4 is a perspective view of the present invention.

FIG. 5 shows an application of the present invention.

FIG. 6 is a perspective view of the pressable switch in another embodiment of the present invention.

FIG. 7 is a perspective view showing a modification of the lampshade in a further embodiment in the present invention.

### DETAILED DESCRIPTION OF THE PREFERRED EMBODIMENTS

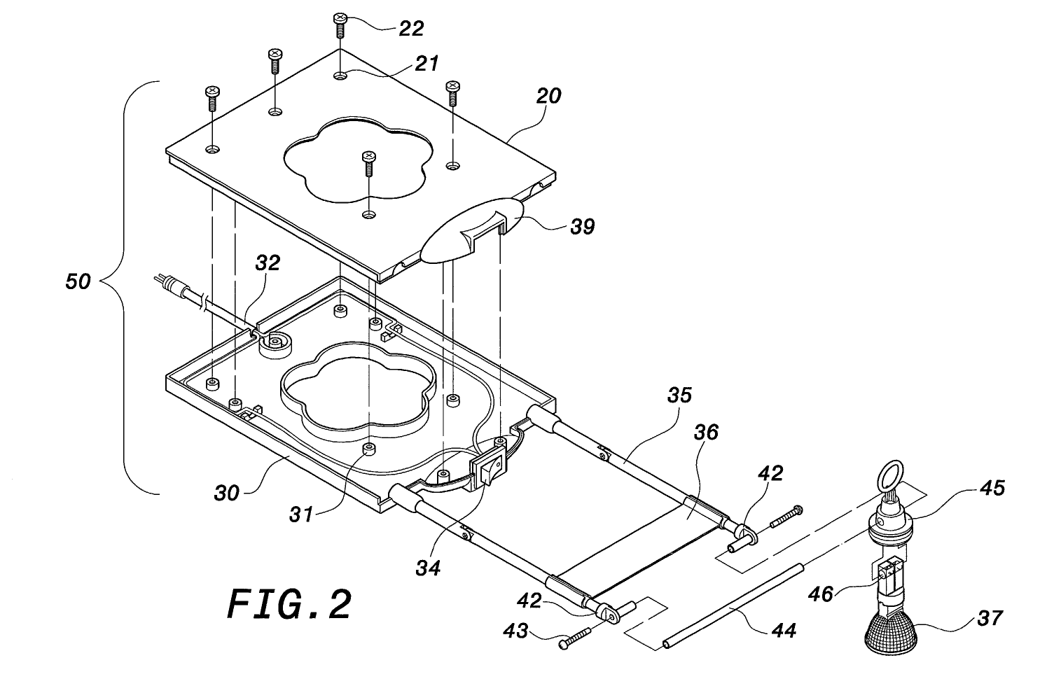

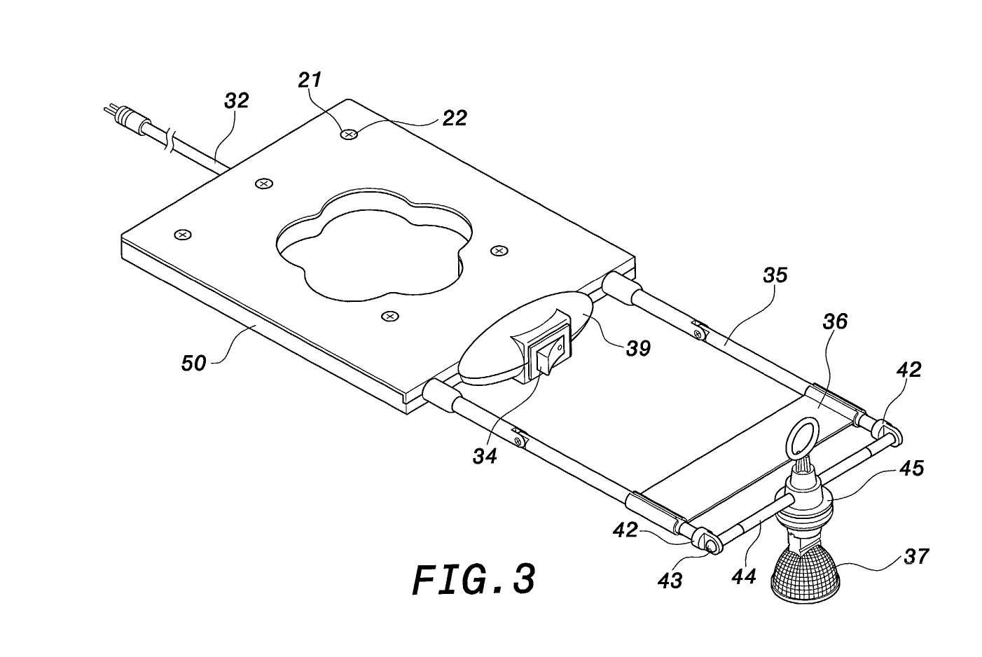

Referring to FIGS. 2 and 3, an illumination device is provided in the present invention, which is especially placed in the compact disk (CD) receiving frame. The present invention includes an upper cover 20 which is hollowed and has a shape like a plum blossom. Each edge of the upper cover 20 is installed with a plurality of holes 21. Each hole 21 is inserted by a screw 22. The screw 22 may be screwedly connected with a box 30. After screwing the upper cover 20 to the box 30, a body 50 is formed. A plurality of cylinders 31 are installed within the box 30. Each cylinder 31 may be screwed and then locked by a screw 22. An electric wire 32 is hidden in the body 50. A rear side of the body 50 is installed with a notch 33. The notch 33 may be inserted by an electric wire 32 conveniently.

A front side of the body 50 is installed with a cover 39. The cover 39 may be connected to a pressable switch 34. One end of the electric wire 32 is connected to the switch 34 and another end of the electric wire 32 is connected to a receptacle (not shown). Two sides of the switch 34 are installed with two rod bodies 35 which are telescopic and bendable. The two rod bodies 35 may be antennas or soft tubes. A plate 36 is installed between the two rod bodies 35. The plate 36 serves to prevent the two rod bodies 35 from being contacted with one another so as to be short-circuited. One end of each rod body 35 is connected to a locking device 42. The locking device 42 serves to lock a rod body 44 with a lock 43. The rod body 44 is inserted by a tapered combiner 45. The combiner 45 is enclosed by a lampshade 37. A bulb (not shown) is mounted within the lampshade 37. The bulb may be fluorescent lamp or a halogen lamp, and other convenient devices. One end of the lampshade 37 is installed with a round hole 46. The round hole 46 serves to be inserted by the rod body 44 so that the lampshade 37 is substantially connected to the combiner 45.

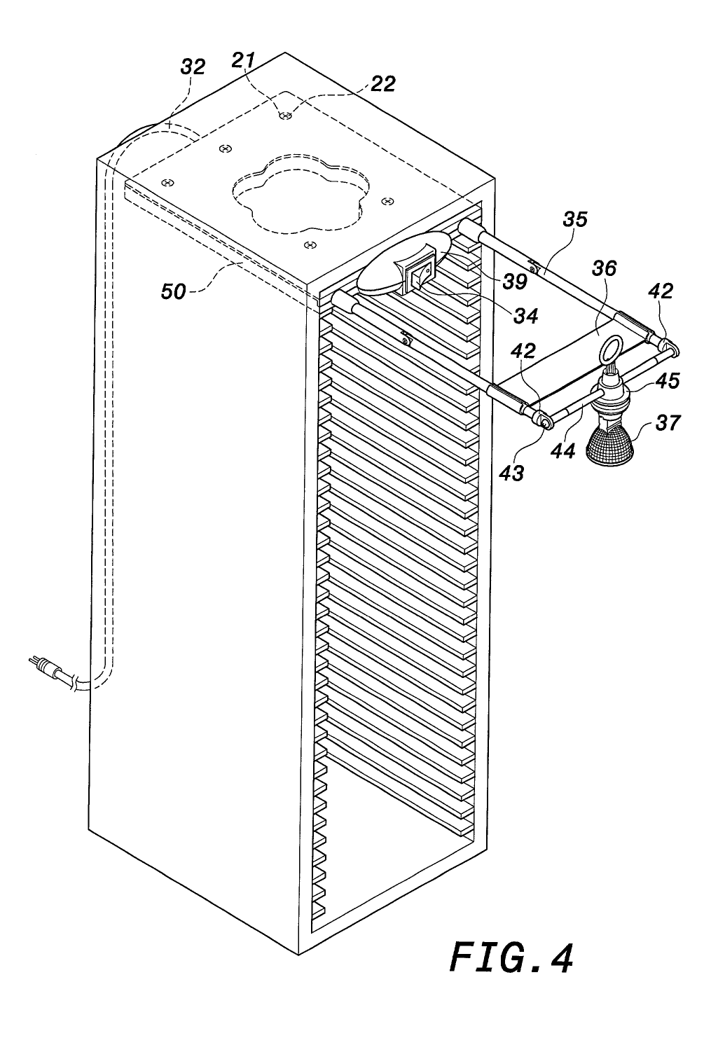

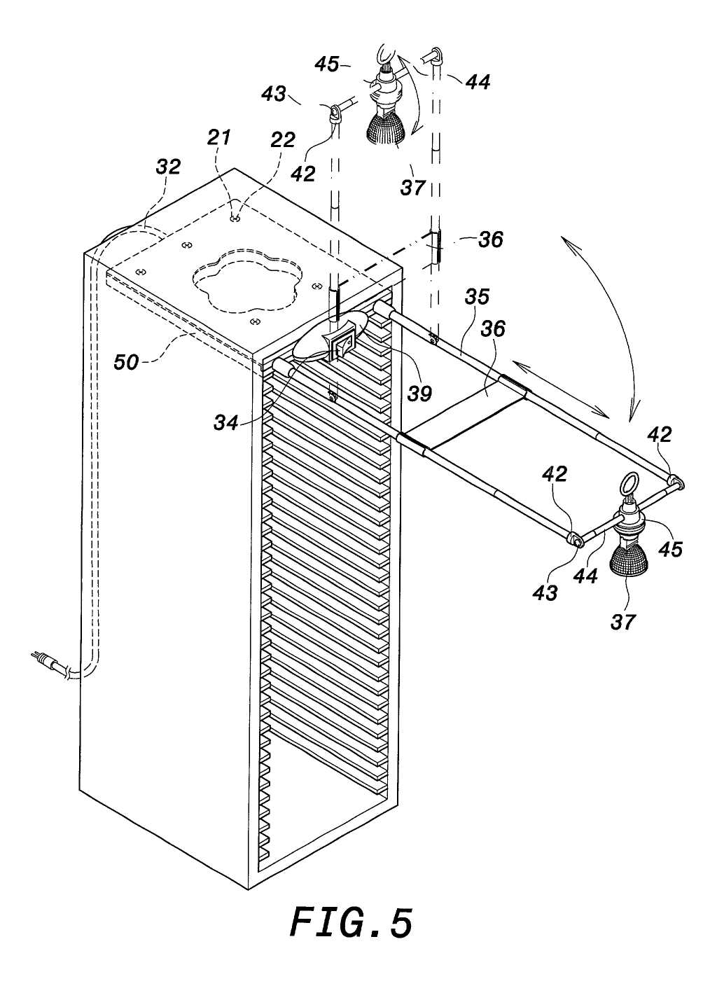

With reference to FIGS. 3, 4 and 5, the body 50 is firmly secured to be in the top of the CD receiving frame 40. Two sides of the CD receiving frame 40 are installed with a plurality of spacers 41 which are positioned with respect to each other, and are spaced with an equal space. The spacers 41 can be arranged with a plurality of compact disks (not shown). The electric wire 32 is hidden in the inner rear side of the CD receiving frame 40. In order to prevent the user from stumbling, the two telescopic and bendable rod bodies 35 protrude from the front edge of the top of the CD receiving frame 40. Thus, the user may adjust the orientation of the lampshade 37 conveniently and read the data (for example lyrics, etc) in the compact disks within the CD receiving frame 40. Therefore, the user may use it conveniently.

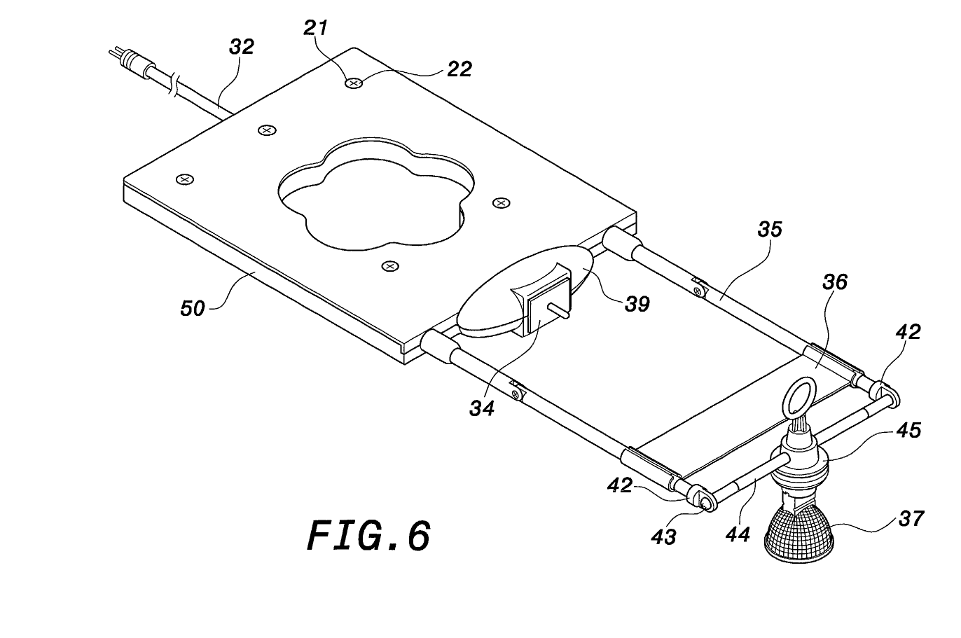

Referring to FIG. 6, another embodiment of the present invention is illustrated. In order to diversify the present invention, a rod type switch 122 can be used to place the pressable switch 34. The mounting and connection of the switch 34 is identical to the aforesaid embodiment.

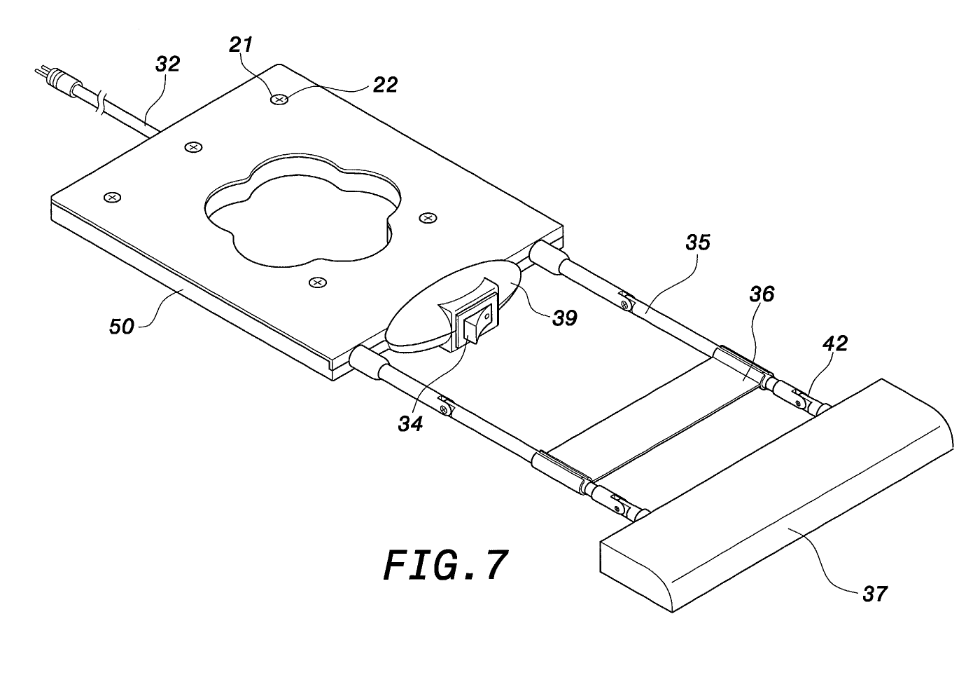

Referring to FIG. 7, another embodiment of the present invention is illustrated. In this embodiment, the lampshade 37 may be designed like an oblong shape. Another, the lampshade 37 may have square shapes, oblong shapes, polygonal shapes, round shapes, elliptical shapes, triangular shapes, tetragonal shapes, etc.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An illumination device comprising a body, the body being hidden with an electric wire; a front side of the body being installed with a pressable switch; two sides of the pressable switch being installed with two rod bodies which are telescopic and bendable; one end of each of the two rod bodies being connected to a lampshade; a lampshade being firmly secured with a bulb; thereby, the illumination device being placed in a CD receiving frame so as to achieve the effect of illumination.

2. The illumination device as claimed in claim 1, wherein the body is formed by an upper cover and a box which are installed with screw holes and studs, respectively, so that the upper cover and the box are screwedly combined.

3. The illumination device as claimed in claim 1, wherein a center of the body is hollowed.

4. The illumination device as claimed in claim 1, wherein the pressable switch is a button switch or a plate type switch.

5. The illumination device as claimed in claim 1, wherein the lampshade has a shape selected from the group consisting of square shape, oblong shape, polygonal shape, round shape, elliptical shape, triangular shape and tetragonal shape.

6. The illumination device as claimed in claim 1, wherein the bulb is one selected from the group consisting of fluorescent bulb and halogen bulb.

7. The illumination device as claimed in claim 1, wherein the two rod bodies are ones selected from the group consisting of an antenna rod and a soft rod.

8. The illumination device as claimed in claim 1, wherein a plate is installed between the two rod bodies, so as to prevent the two rods are contacted with one another so as to be shortened.

9. The illumination device as claimed in claim 1, wherein one end of each of the two rod bodies is connected to a locking device, and the locking device is locked by a lock and then is covered by a lampshade.
